(19) United States
(12) Patent Application Publication
(10) Pub. No.: US 2024/0146230 A1
(43) Pub. Date: May 2, 2024

(54) Photovoltaic Photothermal full conversion automatic tracking all-weather integrated wind light energy intelligent power generation system

(71) Applicant: Shanghai Chengsheng Mechatronics Co., Ltd, Shanghai (CN)

(72) Inventors: Guohua Chen, Shanghai (CN); Kangyuan Chen, Rochester Hills, MI (US); Kaiyuan Chen, Shanghai (CN); Huifeng Yang, Shanghai (CN)

(21) Appl. No.: 18/223,625

(22) Filed: Jul. 19, 2023

(30) Foreign Application Priority Data
Oct. 31, 2022 (CN) 202211352626.X

(51) Int. Cl. H02S 10/30; F03D 9/00; H02S 10/12; H02S 20/32; H02S 40/22

(52) U.S. Cl. CPC H02S 10/30; F03D 9/007; H02S 10/12; H02S 20/32; H02S 40/22; F05B 2220/708

(57) ABSTRACT

An Electric Power Generation System is provided. The system can not only transform visible light in natural sun light to high light intensity parallel cold beams, directly generate electric power with concentrating photovoltaic cells, but also convert invisible infrared radiation heat to high, intermediate and low energy levels' heat for thermal electric power generation. Automatic sun and wind tracking mechanism is equipped with lift-force type high speed fan and resistance-force type low speed fan, a multi level generator is driven by polystage turbines and wind turbines coupled via special powertrain, the above-mentioned machines are all in “multi dimensional maglev state”. Multiple working medium and multiple thermal cycles are adopted to heat energy of different levels, computer intelligent management is performed to different factors' photovoltaic cells, multi stage variable load and velocity generator, rechargeable batteries, loads, power supply to the grid, automatic sun and wind tracking mechanism.

### CROSS-REFERENCE TO RELATED APPLICATIONS

The present application claims priority to Chinese Patent Application CN202211352626X. Filed to the China National Intellectual Property Administration on Oct. 21, 2022 and entitled “photovoltaic photothermal total transformation automatic tracking all—weather integrated wind light energy intelligent electric power generation system”, which is incorporated herein by reference in its entirety.

### TECHNICAL FIELD

The present disclosure is a kind of all-weather integrated sun light photovoltaic, photothermal total transformation and wind energy fully automatic sun, wind direction tracking intelligent efficient power generation system, belongs to the field of power generation equipment.

### BACKGROUND

Throughout the world, the demand and consumption of energy sources grow continuously with industrialization degree rising, however, the technology development in energy source territory can't catch up with the steps of times advancement at all, the world energy source structure still relies on fossil fuels, the fossil fuels are a kind of unsustainable energy which will be exhausted sooner or later, what's more important is that the exhaust gas from consumed fossil fuels pollutes the atmosphere of the earth and global greenhouse effect deepens due to excessive exhaust carbon dioxide, which threaten the survival of mankind directly.

In the territory of new energy source technology, it is solar power generation (including wind energy) indeed who is minimal-pollution and most promising, and our country is leading the world for photovoltaic and wind power generation technology in the field of solar power generation, nevertheless, there is the problem of low power generation efficiency in current distributed photovoltaic power stations and a few photothermal power stations and wind power generation systems that can only be used in solar energy and wind energy rich areas and hardly apply to the whole country or globe.

The present disclosure is indeed a kind of power generation system who can track sun light and wind direction automatically, which collects the sun light, converts the part of visible light to parallel cold beams with high illumination intensity, projects them to multi junction dense grid light concentration photovoltaic cells to produce electric power directly, in the same time, this optical system can also reflect and focus the invisible infrared thermal energy onto a special vacuum heat collection tube which can have the focused IR heat energy heat its internal heat-transferring working medium who enters storage tanks and becomes heat engine working medium after re-heated by heat exchangers, the heat engine working medium drives the multi-level “multidimensional magnetic levitation state” turbines that then spur the multi-step “multidimensional magnetic levitation state” generators to produce electric power.

These special heat concentration vacuum tubes are located on the focal spots of different parts of the optical system, different heat transfer working mediums are adopted in the tubes to form a heat engine thermal cycle system of multiple temperature ranges that can absorb the heat from all temperature sections of the system respectively, becomes heat engine working medium after heating, spurs “multi-dimensional magnetic levitation state” multiple level turbines and thus drives “multi-dimensional magnetic levitation state” multi-step generators to produce electric power.

In addition, there are lift type high speed propeller wind turbine and resistance type low speed tubular fan installed in the machine rack which tracks the sun automatically and coupled in one transmission chain by the multi-step “multi-dimensional magnetic levitation state” accelerator, the action of automatic tracing the sun and wind is confirmed by computer calculation, it is also a computer who performs intelligent management on electric power output, the heating, storage, heat exchange and thermal power generation process, simultaneously on wind fan, the storage of wind energy and power generation process of wind turbine, so the power generation capability can be 3˜6 times that of traditional photovoltaic, photo thermal power generation, though the cost of power generation is only 50% of the photovoltaic power generation, the equipment cost recovery period is 2˜5 years, and the service life of the equipment is 20 years for the whole power generation system, because the “multi-dimensional magnetic levitation state” design is fully applied in the wind turbines and all power machinery, all links of automation.

The power generation equipment of the present disclosure can be popularized and applied in most areas of China and even abroad, not only for grand electric power stations in the areas rich in sun light and wind resource, but also for enterprises, plants, hospitals, communities, residences, schools, organs, army, islands, border defense areas and middle and small power stations in deep forests, remote and poverty-stricken areas.

The present disclosure is created as this kind of efficient intelligent power generation system based on the dissection of technical principle and structure of current photovoltaic, photo thermal and wind power generation and addressing the problems identified.

### SUMMARY

The present disclosure aims at and technically dissects the status of low efficiency of actual utilization of solar energy photovoltaic distribution-type power generation stations, solar energy photo thermal power generation stations (including tower, trough and butterfly-type) widely applied at home and abroad at present and lift-type propel generators already promoted and adopted, so it is found out that there are some defects of principles in the above-mentioned systems.

The distribution-type photovoltaic power station is actually one kind of simplest electric power generation system with the concept of planting widely and harvesting little, although it has the advantage of simple structure and convenient maintenance, it only applies to sun light rich areas, the generated electricity needs to be transmitted to far away industrialized areas with extremely big consumption of electric power via super-high voltage direct current electric grids, so it is quite large for the equipment investment calculated and summarized.

There is one defect in principle of the power generation with photovoltaic cells in photovoltaic power stations; that is to say, the invisible IR heat energy as about 50% of sun light can't be transformed to electric power, furthermore, the photoelectric conversion efficiency of photovoltaic cells is jeopardized by the violent molecular thermal motion in high temperature which decreases photovoltaic power generation efficiency much, i.e., the photovoltaic power generation stations have abandoned 50% heat energy usage in the principle of power generation.

Thermal solar power generation is just the opposite to photovoltaic power generation, collects and raises the heat energy level with reflection focusing method, but gives up the light energy in sun shine (cold light). It can be found out that the efficiency is obviously low to hang a huge boiler high in the open air as heat exchange method, furthermore it has also abandoned the cold light energy which is about 50% of sun light, by the technical analysis on the currently adopted tower-type reflection focusing power generation systems.

Besides, thermal solar power generation is restricted by climate much more than photovoltaic power generation, the latter one can produce electric power no matter cloudy, overcast or rainy days only with lower capacity, nevertheless, thermal solar power generation needs special optical climate environment, i.e., sun light rich areas, the power generation basically stops in cloudy, overcast or rainy days, hence, this kind of thermal solar power generation can hardly exceed photovoltaic power generation on the power generation capacity as a matter of fact, as a result, thermal solar power generation is 5˜20 times equivalent capacity photovoltaic power generation in the equipment investment amount.

The current wind driven generators are almost all lift type propeller high speed wind fans imitating foreign products; they are a kind of low torque high speed wind fan only suitable to wind energy rich areas actually, in the other areas, the fan halt time is much longer than run time, so the wind energy conversion efficiency is 40% at most.

The present disclosure is the kind of efficient intelligent power generation system created based on the dissection on the technical principle and structure of the current photovoltaic, thermal solar and wind power generation and aiming at the discovered problems.

The core technical content is stated below for the present disclosure:

It adopts reflection and light concentration lens group with special shape and functions, the surface has been treated specially for these reflection light-concentration lens and they are combined and arranged along the central axis.

Many special vacuum heat concentration tubes are located on the reflection focus focal spot, in addition, a lot of heat exchangers in all kinds of shapes are set up on the opposite of the special vacuum heat concentration tubes, the thermal working medium in the heat exchanger is heated by the heat transferring working medium in the heat exchanger from absorbed IR heat energy, this thermal working medium can be used for thermal power generation.

The multi junction dense-grid light concentration photovoltaic cell panel is configured on the heat exchanger surface opposite to incident IR rays, to accept the high light intensity parallel cold beams reflected by the cold light lens of special vacuum heat concentration tubes, the photovoltaic cell panel accepts the high light intensity parallel cold beams and converts them to electric power directly.

There is cold lens surface on the opposite plate to many kinds of vacuum heat concentration tubes set on emission focus spot of focus reflection lens, it can not only reflect and convert the incident focus light to high light intensity parallel cold beams, but also have the focused IR heat penetrate itself and focus onto the stainless steel tubes at the center of many kinds of special vacuum heat concentration tubes, as the tubes are filled by different heat conveying working medium (salt, oil, low melting point metal), these working medium absorbs the focused IR heat and is transmitted to storage tank, vaporizes the heat engine working medium with the heat via heat exchangers, the heat engine working medium drives poly-step “multi-dimensional magnetic levitation state” turbines and further spurs poly-level “multi-dimensional magnetic levitation state” generators to produce electric power.

According to the above-mentioned principle, various embodiments of optical systems can be developed for selection, which can apply to different climate conditions and variant locations, build up mathematic models, with calculation upon meteorological big data, reliable data can be raised for design of power generation system with the highest power generation efficiency.

By way of illustration and not limitation, there are 9 embodiments (I-IX) described below for the above mentioned optical system:

The optical system I is a kind of channel type reflection focusing in medium focal ratio power generation system, consists of 3 layers of reflection glass mirror with treated surface, 3 special vacuum heat concentration tubes and 3 heat exchangers. The heat concentration tube on the first layer heat focusing reflection glass mirror's focal spot can absorb above 90% IR light heat energy in incidence sun light, conduct to heat storage working medium, and delivered to heat storage tanks for thermal power generation; meanwhile, the high light intension parallel cold beams are utilized to produce electric power directly via multiple junction dense grid light concentration photovoltaic cells configured on the heat exchangers' surface, next, above 80% of visible light focuses on 2^{nd} special heat concentration tube through the heat reflection mirror, transforms to high light intensity parallel cold beams, project to multiple junction light grids light concentration photovoltaic cells on heat exchangers' surface to generate electric power directly. The 2^{nd} layer cold light film reflection glass mirror and 3^{rd} layer full reflection mirror, per the above-mentioned principle, different heat storage working medium and heat thermal working medium can be selected on the vacuum heat concentration tubes and heat exchangers on different positions on their focal spots and different working temperature ranges to provide the power generation system's poly thermal cycles with different energy levels' heat source, the opposite heat exchanger's heat concentration photovoltaic cells accept the high light intensity parallel beams to generate power directly.

This optical system applies to sun light rich areas with more than 300 sunny days per year and maximizes power generation efficiency.

Optical system II also belongs to channel type medium focal ratio electric power generation system, consists of 1 heat reflection mirror, 1 full reflection mirror and 2 special vacuum heat concentration tubes, the infrared light energy in incidence sun light is reflected and focused to vacuum heat concentration tubes by the heat reflection mirror, absorbed by the heat storage working medium in the vacuum heat concentration tube and delivered to heat storage tanks, heat thermal heat working medium via heat exchanger to spur turbine to drive generators to produce electric power by thermal power.

At least 20% visible light is transformed to parallel high light intensity cold beams by cold light mirrors on heat concentration tubes, shot to and absorbed by multi junction dense-grid light concentration photovoltaic cells on the surface of heat exchanger to generate electric power directly; in parallel, about 80% of visible light projects to monocrystalline (or polycrystalline) silicon photovoltaic panels in the middle through heat reflection mirror, the penetrating cold light energy is all used to generate electric power directly with the photovoltaic panels. They shot to full reflection glass mirror that the little infrared energy and ultraviolet light not absorbed by photovoltaic panels yet, this reflection glass mirror focuses the little IR light and visible light on 2 cold light mirrors of the 2^{nd} special vacuum heat concentration tube, 1 cold light mirror can have focused IR heat energy penetrate into heat concentration tube, absorbed by its internal heat storage working medium and transport to heat storage tanks for thermal power generation; meanwhile, the focused visible cold light beams are converted to parallel beams and project to poly junction dense-grid light concentration photovoltaic panels for direct electric power generation by the 2^{nd} cold light glass mirror on the heat concentration tube surface.

The above-mentioned optical system applies to solar energy available areas and lack of solar energy areas, because it is considered much that solar energy photovoltaic electric power generation in cloudy, overcast and rainy weather, the power generation efficiency of the whole system is more than 2 times the current traditional distributed photovoltaic power generation and the other systems as adopting adapted common silicon photovoltaic cell panels and integrating wind energy power generation system although the efficiency is lower than system I.

The power generation principle is basically same as the optical systems I and II for III and IV, the main change is adopting butterfly arrangement to achieve higher focal ratio, it is similar to that of the systems I and II for the structure and principle of the special vacuum heat concentration device in III and IV, this kind of focal ratio can be up to 1 K through 10 K or even higher, which expands the room to save photovoltaic components but supposes higher requirement on light concentration photovoltaic components though enhance light energy conversion efficiency correspondingly, especially thermal power generation efficiency, and the application scenario is similar to above-mentioned systems I and II for III and IV.

The optical systems V and VI subject to another kind of optical system with comprehensive structure characteristics, in the optical system V, it is half—half for I and II structure composition respectively, it can be figured out with mathematic models according to big data of local climate conditions for the structure composition configuration.

They are supplemented to the type I structure of the optical system VI for 2 inter-perpendicular full-reflection flat mirrors, this light-separating structure has collected sun light and 45° reflection mirror form the best projection angle to realize that more than 80% of IR heat transmits to the special vacuum heat concentration tubes of reflection light concentration mirrors, the heat storage working medium clouded in the tubes absorbs the focused high temperature heat and transfers to heat storage tanks, heats the thermomechanical working medium via heat exchangers, spurs the turbines to drive the generators to create electric power finally.

In parallel, a little visible light energy is focused on cylindrical reflector on heat collector, reflected to band like parallel high intensity beam, projects to the multi junction dense grid concentrating photovoltaic panel on the surface of heat exchangers, so as to convert the high intensity light energy of visible light to electric power, meanwhile, separated to 2 inter-perpendicular visible light beams by flat reflection mirrors, the 2 beams as 90% of illumination light energy are focused on the special vacuum heat concentration tubes by full reflection mirror, the cold light mirror on the heat collection tube is capable to transform focus beams to high intensity parallel beams, cast to multiple junction dense grid concentrating photovoltaic cell panels on heat exchangers to generate electricity directly.

The other 50% casted sun light is distributed at upper and lower 2 ends of the optical system, 25% respectively on each end, the structure completely matches for the 2 optical components and type II, the purpose is that this system's II can still generate electricity in cloudy, overcast or rainy days when type I cannot generate electricity, as a result, this system applies to more areas.

The optical systems type VII and VIII also belong to trough form medium focal ratio reflection focus system, type VII optical system only uses 1 all reflection mirror, at whose light axle center 1 special vacuum heat collection tube is set up, high energy level IR heat energy in the focused sun light beams focuses through the cold light lens into this special vacuum heat concentration tube, gets absorbed and transferred to the heat-transfer medium stored and filled in the tube, the already heated heat-transfer medium is transported to heat storage tank, heats the heat engine medium via heat exchanger, drives “multidimensional magnetic levitation state” poly-step turbine which spurs “multidimensional magnetic levitation state” multi-stage generator to produce electricity.

Synchronously, visible light focused on focal spot is reflected to parallel beams (cold light) parallel to center line by mirror plane on the special vacuum heat collection tube, project to the heat exchanger on the center axis on the opposite plate, multiple junction dense grid light concentration photovoltaic cell panels are equipped on the plate opposite to the heat exchanger, which can generate electrical power directly with the light energy of the high intensity parallel strong beams.

Meanwhile, the heat storage medium filled in the heat exchanger absorbs the surplus heat in light concentration parallel strong beams and transports to heat storage tank to supply lower energy level heat by heat engine medium, the heat engine medium drives “multidimensional magnetic levitation state” poly-stage turbine and spurs “multidimensional magnetic levitation state” multiple step generator to generate electric power.

In a similar way, the optical system type VIII also adopts one focus all reflection lens, the difference from type VII is that one heat concentration tube with 2 inter-perpendicular cold light mirror plates is configured on the focal spot of this focus reflection lens, the tube can convert the already focused high intensity beams to 2 inter−180° nearly parallel reflection strong beams, 2 box type heat exchangers are set up on the opposite plates of these 2 reflection beams, the heat exchangers are filled with heat storage medium which is heated and then conveyed into storage tank to heat thermal engine working medium to gasify and drives multiple stage “multidimensional magnetic levitation state” turbines so as to spur multiple stage “multidimensional magnetic levitation state” generators to generate electric power. The thermal power generation efficiency of this optical system is higher than type VII.

The optical system type IX consists of 2 light concentration reflection lens and 2 special vacuum heat concentration tubes on the corresponding focal spot, the characteristics of this optical system are to firstly adopt heat reflection lens to focus and reflect invisible IR heat energy to 1^{st} special vacuum heat concentration tube equipped on focal spot, the diathermy cold light lens are equipped on the plate opposite to this heat collection tube, which can have 90% of the focused IR heat energy be absorbed by heat conduction working medium in the heat collection tube, then the heat conduction working medium is transported into the storage tank and heated to thermal engine working medium by heat exchangers to drive turbines so as to spur “multidimensional magnetic levitation state” multiple stage generators for electric power generation.

In the same time, there is still 20% visible light energy to be transformed to high intensity parallel beams to cast to the heat exchanger on coaxial center, multiple junction dense grid light concentration photovoltaic cell panel is installed on the plate opposite to the heat exchanger, can accept the light energy of the high intensity beams to generate electric power directly.

Similarly, 80% visible light traverses thermal reflection lens and projects to the second all reflection mirror which focuses and reflects to the second special vacuum heat collection tube positioned on the light center focal spot, the cold light lens on this vacuum heat concentration tube may convert 80% of visible light to high intensity parallel beams that are reflected to the multiple junction dense grid light concentration photovoltaic cell panel equipped on the heat exchanger surface on the plate opposite to its center axis, this cell panel should accept high intensity parallel beams to generate electric power directly.

In parallel, the focused IR light energy shall go through the film layer on the cold light lens on the second special vacuum heat concentration tube and become absorbed by internal heat conduction working medium which is heated and input to storage tank, heated to mechanical working medium via heat exchangers so as to drives poly-stage “multidimensional magnetic levitation state” turbines to run and further spurs poly-stage “multidimensional magnetic levitation state” generators to produce power.

The optical systems designed per the above mentioned principle, including the listed9 types of typical optical systems, are all capable to realize efficient full conversion of photovoltaic and thermal solar power generation, this kind of optical system can obtain high light intensity cold beams, have the power generation system own high transformation efficiency of luminous energy, create basic condition for light concentration photovoltaic cells. The manufacturing cost of power generation system can decrease obviously as the consumption quantity of photovoltaic components in power generation system is dramatically reduced by an order of magnitude with the increase of optical system focal ratio.

The optical system designed per the above-mentioned principle goes through multiple-level reflection focus, highly efficient collection of all usable heat energy can be embraced by the heat extraction system in the center of which all temperature range special vacuum heat concentration tubes are configured, the system achieves the target of high efficiency and energy saving for each link of the whole power generation system.

The power generation efficiency of the power generation system can be further enhanced by all mechanical transmission and power machinery in the present disclosure, i.e., turbines, generators, wind fans all adopting multi-level “magnetic levitation state” design. Similarly, “multi-dimensional magnetic levitation state” design is applied for lift propeller fan and resistance type tubular wind turbine integrated and installed in the power generation system, can solve the problem of long time power generation from fans in non-wind field conditions, establishes good conditions of friendly matching electric power grids, better solves the problem of noise and ecology derived from wind turbines.

The purpose of extending running time and reducing noise can be achieved because the “multi-dimensional magnetic levitation state” design is adopted by all drive chains of the whole generator set, the impact to the system's transmission efficiency is extremely small from the length of drive chains, which makes it possible that the drive chains design in the generator set design further fit the requirement of the whole system power generation, the output torque is bigger for resistance type, tubular type fans for instance.

The automatic tracing transmission system adopted by photovoltaic, thermal solar and wind power generation in the above-mentioned power generation systems is shared by multiple kinds of power generation modules and also shared as resource by DC/DC convertors, DC/AC invertors, output controllers, power storage accumulators, “multi-dimensional magnetic levitation state” poly-step generators, and thermal energy controllers as well in the above-mentioned photovoltaic, thermal solar and wind power generation, which arises to increase the usage rate of the whole system and reduce the manufacturing cost of the machine sets.

In the above-mentioned power generation system, to enhance the power generation efficiency of the thermal solar power generation system, we adopt to the multiple optical systems in the thermal solar power generation module the many special vacuum heat concentration tubes that are capable to obtain the heat of different temperature ranges efficiently and robustly, adopt various heat engine working mediums to perform driving in all multiple grades “multi-dimensional magnetic levitation state” turbines, so as to achieve higher efficiency of power generation, i.e., exceed “Rankine” cycle or even exceed thermal power generation efficiency of “uehara” cycle invented by Japan.

The present disclosure illustrates compact structure, robust functions, efficiency of power generation 3 through 6 times the distributed photovoltaic power stations, optical thermal power stations and pure wind power generation systems with calculation per equivalent light/wind-capture areas).

After calculation on meteorological big data the driving system, power machinery, generators and wind fans are all “multi-dimensional magnetic levitation state” and many kinds of optical systems can realize simultaneous full transformation of photovoltaic and optical thermal power.

This is a power generation system environment-friendly and electrical grid-intimate, ideal and clean without pollution, suitable to build up grand power stations, also middle to small power stations for enterprises, plants, hospitals, communities, residences, schools, army, islands, border defense areas and deep forests, remote and poverty-stricken areas.

Since every power generation module sufficiently realizes resource sharing and intelligent management with computers in the power generation system, the application is convenient, the maintenance cost is low, development and usage are appropriate; in addition, equipment manufacturing cost is lower, equipment operation payback period is short generally 2 through 5 years, the service life of the equipment is 20 years equivalent to distribution-type photovoltaic power generation stations.

### BRIEF DESCRIPTION OF DRAWINGS

FIG. 1 is a principle flow chart of the “Photovoltaic Photothermal Total Transformation Automatic Tracking All—Weather Integrated Wind Light Energy Intelligent Electric Power Generation System”.

FIG. 2 is a sketch map of the intelligent power generation system of Photovoltaic Photothermal Total Transformation sun-wind Automatic Tracking All—Weather Integrated Wind Light Energy with the principle of the type II optical system.

FIG. 3 is a schematic diagram of variant-working-medium internal cycle thermal power generation system of “Photovoltaic Photothermal Total Transformation Automatic Tracking All—Weather Integrated Wind Light Energy Intelligent efficiency Electric Power Generation System”.

### DETAILED DESCRIPTION

The present disclosure is introduced further below combined with annex diagrams and vivid instances, but it shall not be regarded as a limitation of the present disclosure.

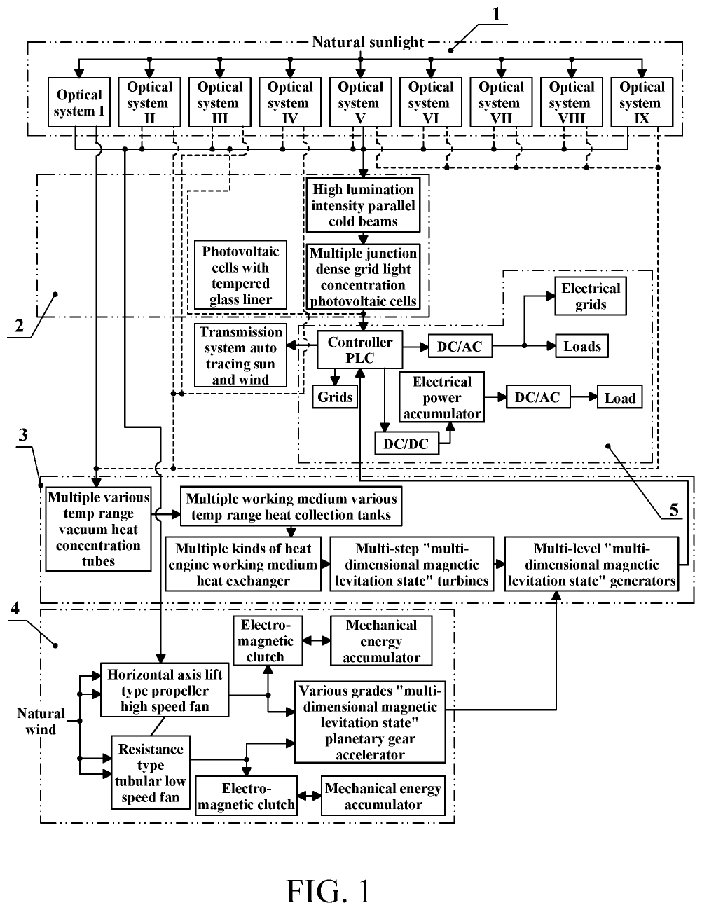

As FIG. 1, Principle flow chart of the “Photovoltaic Photothermal Total Transformation Automatic Tracking All—Weather Integrated Wind Light Energy Intelligent Electric Power Generation System”, it can be seen from FIG. 1, the power generation system includes the following 5 modules, among which 1 is sun-wind automatic tracing module adopting optical systems I˜IX, 2 is photovoltaic power generation module, 3 is photothermal power generation module, 4 is wind fan power generation module, 5 is auto control intelligent management module.

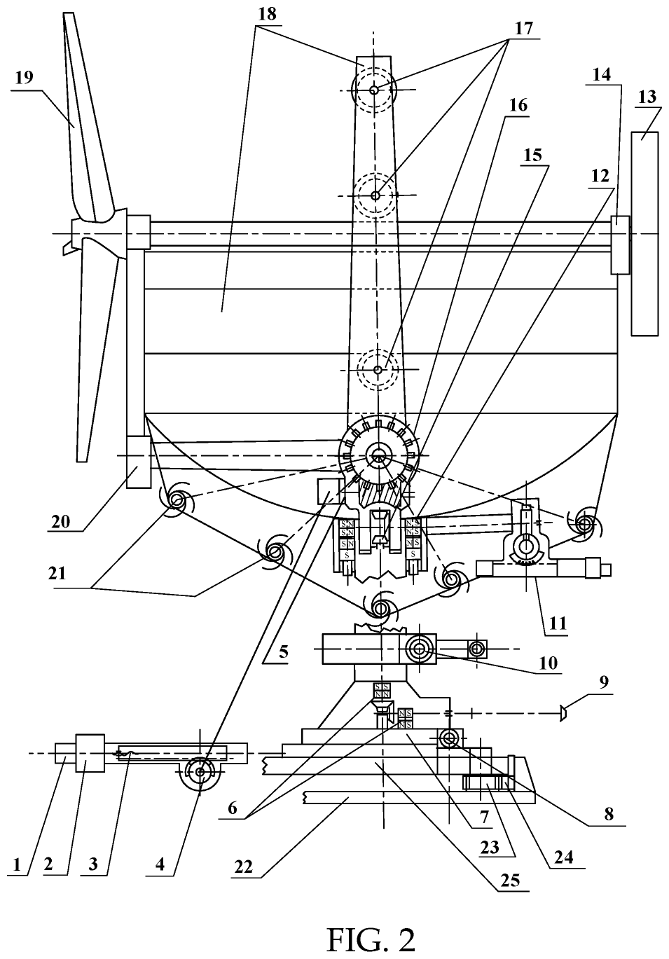

It can be figured out from FIG. 2, that the power generation system assembled per optical system II, thereinto which, 17 is 3 special vacuum heat concentration tubes, they can efficiently collect infrared heat energy, also heat different heat transmission working mediums, then convey the heat transmission mediums into the storage tank on the index table 25, when the storage tank is full, the working mediums can be output or input to the fixed heat tank groups via central axis tubes on index table 25 through quick couplers from tubes. The heat tanks are equipped with heat exchangers, can heat up the heat engine working mediums with the reserved heat, further by the heat engine mediums spur the multi-level “multi-dimensional magnetic levitation state” turbines and thus drive the multi-step “multi-dimensional magnetic levitation state” generators to produce electricity, realize intelligentization under the management of computers and PLCs, supply to loads, power storage accumulators or electrical grids the electricity.

Simultaneously, these 3 special vacuum heat concentration tubes (17) can also convert visible light to high light intensity parallel cold beams, the cold beams are efficiently transformed to electrical energy by light concentration photovoltaic cell panels in the optical system, and via electrical cables with PLCs and computers smart management, deliver electricity to loads, power storage accumulators or electrical grids.

Besides, as shown in FIG. 2, 19 is lift type propeller high speed wind fan, 21 is resistance type tubular low speed wind fan, via the high speed arose from multi-level “multi-dimensional magnetic levitation state” accelerators drive poly-step “multi-dimensional magnetic levitation state” generators to produce electricity. Identically, by PLC/computers managed intelligently, deliver electricity to power storage accumulators, loads or direct grids.

Besides, as shown in FIG. 2, 19 is lift type propeller high speed wind fan, 21 is resistance type tubular low speed wind fan, via the high speed arose from multi-level “multi-dimensional magnetic levitation state” differential planetary gear accelerator drive poly-step “multi-dimensional magnetic levitation state” generators to produce electricity. Identically, by PLC/computers managed intelligently, deliver electricity to power storage accumulators, loads or direct grids.

The 2 kinds of fans (19 and 21) are linked by multiple motion transmission pairs and then input to poly-level “multi-dimensional magnetic levitation state” accelerators, meanwhile, these many motion transmission pairs are also connected to mechanical energy accumulator (13 in the figure), can store energy appropriately, in case of too big wind, via the motion transmission pairs and through the central axle of the index table, with the output shaft on the substrate, then passing electromagnetic clutch, add pressure to the fixed mechanical energy accumulator assembles, inertial flywheel sets or high pressure gas pumps of heat engine working mediums and embark storage tanks, in which way store the redundant mechanical energy to go on to generate electricity via heat engine when wind energy shrinks, or continue power generation via electromagnetic clutch releasing the mechanical energy reserved in the inertial flywheel set, in conclusion create conditions for all-weather power generation.

Variant propeller minus load components are not designed for this wind generator sets, with the support of enough power transmission rigidity and transmission system with sufficiently big reverse torque, can reach maximal energy storage effect, in order to increase the total power generation efficiency of the power generation system.

It can be found out from FIG. 2, base plate 22 is fixed on supporting mass, where ring type gear rack 24 and circular I-shaped rail are fixed, the plate 25 is supported by 4 roller assemblies, one or two pillars are installed on the plate 25, these two pillars support the whole mechanical motion transmission mechanism automatically tracking the Sun and wind direction. Furthermore, there are enough storage tanks for all kinds of heat transferring working mediums and heat engine working mediums, and pump stations for various kinds of heat transferring working mediums and heat engine working mediums, thermoelectric generator sets, and via poly-step “multi-dimensional magnetic levitation state” accelerator coupling wind fans, can sum up mechanical energy of wind fans and thermoelectric convertors together to produce electricity.

The above machine sets are installed on the same platform (25), and then make planetary motion along the circular gear rack on the chassis by spurring the gear via the transmission assembly on its two pillars, sequentially drive the whole machine set to revolve around the center of round chassis (22), to meet the requirements of tracking the Sun and wind direction.

To accomplish high efficiency of transmission system, it's indispensable to own reverse braking torque, there are torque motors—decelerators—transmission of precision ball screws—transmission of precision gears and gear racks—meshing rotation of transmission gears and circular gear racks (24) in the motion transmission box adopted as transmission assembly, drive the platform (25) to revolve along the axle of the index table, the figure shown transmission component 10 is set up on the two pillars, this transmission component is one linear ascendant and descendant transmission chain comprised from torque motor—decelerator—ball screw, this transmission chain also owns the ability of high reverse braking torque, the figure shown two pillars are able to move up and down, on which there is one hinged installed assembly, can make latitudinal motion tracing the sun and wind via torque motor—decelerator—ball screw—precision gear and gear rack—index transmission box—swing of swing arm, there is one assembly (11) configured at the upper end portion of the swing arm (5), which is one transmission mechanism in the same transmission principle who can finish longitudinal swing work needed by the tracking of the Sun and wind.

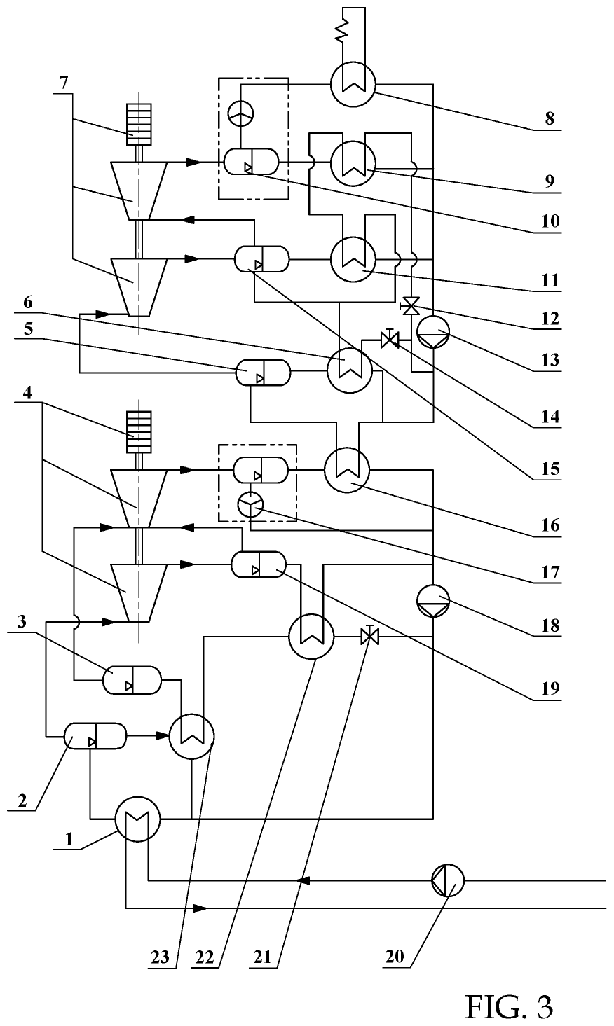

The annex FIG. 3 is schematic diagram of the twin-working medium, thermal energy internal cycle in the “Photovoltaic Photothermal Total Transformation Automatic Tracking All—Weather Integrated Wind Light Energy Intelligent Efficient Electric Power Generation System”. Where 1 is just heat transferring working medium in the power generation system, it is pumped into heat exchanger, and heated up to more than 400 degree Celsius by heated heat engine working medium water, there is high-temperature high-pressure gas separated from the generated over-heated steam via steam separator 2 and enters step 2 turbine (4) to drive poly-level generator to produce electricity, in parallel, the hot water separated from over-heated steam by steam separator enters the heat exchanger 23, through the reheating of the heat exchanger, the hot water separated from the exhaust gas discharged from the first stage of the turbine via steam separator 19 is thus separated to relatively higher temperature steam (approximately 250 degree Celsius) through 3 and then run into the second grade of the turbines to carry out power generation as well.

The exhaust gas discharged from this second grade is converted to liquid by the condenser 17, that is to say hot water (the temperature about 60˜80 degree Celsius), enters the heat exchanger 16 and heat the second working medium (ammonia water), the heated ammonia water suddenly inflates, via vapor separator 5 inputs to and drives the second step 2 turbine so as to spur generator to produce electricity. The exhaust gas released from the first grade of the second level 2 turbine enters vapor separator 15, the separated ammonia water runs into the heat exchanger 11, it heats the 2nd grade exhaust gas discharged by the second turbine, the exhaust gas inputs to the 2nd grade turbine of the 2nd turbine together with the gas heated by the heat exchanger 6 via vapor separator. The exhaust gas of the second turbine goes into the heat exchanger 9 for heating after being discharged, then input to the heat exchanger 11 for reheating, separated by vapor separator 15, finally enters the 2nd grade of the second steam turbine and thus takes part in power generation. The condenser 10 is connected with outdoor cooler 8 as one mass, to strengthen condensing effect. 13 and 18 are conveying pumps respectively to transfer 2 kinds of heat engine working mediums (water and ammonia water), the two solenoid valves 12 and 14 possess the effect of controlling transportation cycle programs and flow rates.

The disclosure has been presented in conjunction with several illustrative embodiments, and additional modifications and variations have been discussed. Other modifications and variations readily will suggest themselves to persons of ordinary skill in the art in view of the foregoing discussion. For example, the subject matter of each of the embodiments is hereby incorporated by reference into each of the other embodiments for expedience. The disclosure is intended to embrace all such modifications and variations as fall within the spirit and broad scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A photovoltaic photothermal system for electric power generation, comprising an optical system comprising geometric shapes and different-material film-coated tempered glass, corrugated stainless steel tubes, and vacuum heat concentrating tubes;
wherein the system is configured to convert captured natural parallel sun light to high-intensity parallel cold beams, simultaneously decompose high energy level infrared light, absorbed by the working medium in the vacuum heat concentrating tubes and conveyed to storage tanks, producing high-temperature-pressure intensity different working medium airflow via heat exchanger, push multidimensional magnetic levitation state multi-stage turbines to drive multidimensional magnetic levitation state polystage generators to generate electric power with visible light in captured natural sun light via photovoltaic cells and with invisible infrared light heat energy via thermal mechanical conversion.

2. The photovoltaic photothermal system for electric power generation according to claim 1,
wherein the vacuum heat concentration tubes comprising: different shapes, cladding material and textures glass tubes with stainless steel pipes installed internally, the tubes and pipes heated, fused, and connected with a glass tube hose nipple;
wherein housing material of the vacuum heat concentration tubes is configured per different position in the optical system, the housing is odd shape and special shape cylindrical or spherical plate center section in light receiving places, wherein a certain mathematic relation exists among the shape factors, their homologous light receiving places and center section shape,
wherein the light receiving surface of the vacuum heat concentration tube is cold light lens, a surface of the housing is all-reflection mirror.

3. The photovoltaic photothermal system for electric power generation according to claim 1, further comprising an auto—sun and wind direction—tracking drive system, the system having an ultra-high retarding torque, resistant to grade 12 typhoon, where automatic warp and weft motion is realized by the machine frame driven via the drive system consisting of ball screws, precise gear racks and gears by torque motors.

4. The photovoltaic photothermal system for electric power generation according to claim 1, wherein the multidimensional magnetic levitation state runs through all transmission links of all power-generating units, comprising the drive systems, poly-step turbines, multi-grade generators, resistance type high torque low speed tubular wind turbines, lift type low torque high speed wind turbines and accelerators to couple the two kinds of wind turbines.

5. The photovoltaic photothermal system for electric power generation according to claim 1, further comprising a multiple level “multidimensional magnetic levitation state differential planet gear accelerator, the accelerator configured to be adopted in an integrated solar energy and wind energy's drive system, this accelerator can sum up to the same output shaft the wind power torque of the high speed lift propeller fan and low speed resistance type tubular wind turbine assembled on the same automatic sun and wind tracing rack, drive the multidimensional magnetic levitation state poly-step generator to produce electric power and
the multiple level multidimensional magnetic levitation state turbine outputs the different torque from different working medium in thermal power generation, the torque output from the turbine is transferred to the same poly-step multidimensional magnetic levitation state generator, to achieve resource share.

6. The photovoltaic photothermal system for electric power generation according to claim 1, the working medium, multiple thermal cycle power generation system collects the heat of high, middle, low different temperature segments with the vacuum heat concentration tubes in different parts of different optical systems, the multiple thermal cycle is carried out then, which makes the power generation system harvest higher than the traditional Carnot cycle, Rankine cycle, Japanese Uehara cycle.

7. The photovoltaic photothermal system for electric power generation according to claim 1, further comprising a control system configured to include harvest of natural sun light energy, natural wind energy, tracing the sun and wind, identify different lighting and different wind energy levels, determine the action of tracking control system after calculation in the all-weather integrated solar energy, wind energy, photovoltaic photothermal all conversion sun and wind automatic tracking high efficiency power generation system;
wherein the system is configured to manage output rating of the multiple level multidimensional magnetic levitation state generator controlled in the thermal power generation system, and the output of the electric energy obtained via heat engine conversion, the transportation, storage of heat storage working medium and heat exchanger in thermal power generation, the storage and heat exchange of heat engine working medium and the running of poly-step multidimensional magnetic levitation state turbine, operation of fans, and mechanical energy storage;
wherein the control system of automatic sun tracking to be chosen, the storage, on grid and usage by work load shall be managed via accepting a signal from multidimensional magnetic levitation state anemoscope and determining automatic tracking action and dealing with the electricity from the system's photovoltaic and photothermal power generation by computers;
wherein the heat collection, convey, storage of heat transfer working medium and heat engine working medium, the process of thermal power generation and wind power generation are configured to be managed so as to achieve the effect of efficient power generation of the system.

8. The photovoltaic photothermal system for electric power generation according to claim 1, wherein the optical system is a channel-type reflection focusing medium focal ratio power generation system, and comprises three layers of reflection glass mirror with treated surface, three vacuum heat concentration tubes and three heat exchangers;
wherein a heat concentration tube on the reflection glass mirror of the first layer can absorb above 90% infrared (IR) light heat energy from incidence sun light, conduct to a heat storage working medium, and delivered to heat storage tanks for thermal power generation; the high-intensity parallel cold beams are utilized to produce electric power directly via multiple junction dense grid light concentration photovoltaic cells configured on the heat exchangers' surface; over 80% of visible light onto the second heat concentration tube through the heat-focusing reflection glass mirror converted into high-intensity parallel cold beams and directed towards multiple junction light grid concentration photovoltaic cells, located on the surface of the heat exchangers, enabling direct electricity generation;
wherein the system incorporates a second layer comprising a cold light film reflection glass mirror and a third layer comprising a full reflection mirror; these layers allow for the selection of different heat storage working mediums and heat thermal working mediums within the vacuum heat concentration tubes and heat exchangers; by choosing different positions and working temperature ranges, the system can provide polythermal cycles with heat sources of varying energy levels; the heat concentration photovoltaic cells in the opposite heat exchanger accept the high-intensity parallel beams and directly generate power.

9. The photovoltaic photothermal system for electric power generation according to claim 1, wherein the optical system is a channel-type reflection focusing medium focal ratio power generation system, comprising a heat reflection mirror, a full reflection mirror and two vacuum heat concentration tubes;
wherein the heat reflection mirror reflects and focuses the infrared (IR) light energy from the incident sunlight onto the vacuum heat concentration tubes, the infrared (IR) light energy is then absorbed by the heat storage working medium within the vacuum heat concentration tubes and delivered to the heat storage tanks; the heat thermal engine medium, via a heat exchanger, drives a turbine to drive the generator to generate electric power through thermal power conversion;
wherein at least 20% visible light is transformed into parallel high-intensity cold beams by the cold light mirrors positioned on the vacuumheat concentration tubes, the cold beams are then absorbed by multi junction dense-grid light concentration photovoltaic cells located on a surface of the heat exchanger to generate electric power directly; 80% or less of the visible light passes through the heat reflection mirror and reaches monocrystalline (or polycrystalline) silicon photovoltaic panels in the middle; the penetrating light is fully utilized to generate electric power directly with the photovoltaic panels;
wherein the little infrared light and visible light that are not absorbed by the photovoltaic panels are directed towards the full reflection glass mirror; the reflection glass mirror focuses the infrared (IR) light and visible light onto the two cold light mirrors of the second vacuum heat concentration tube; one cold light mirror enables the penetration of focused infrared (IR) heat energy into the heat concentration tube, which is then absorbed by its internal heat storage working medium and transported to the heat storage tanks for thermal power generation;
wherein the focused visible cold light beams are converted into parallel beams and project to poly junction dense-grid light concentration photovoltaic panels for direct electric power generation by the second cold light glass mirror located on the heat concentration tube surface.

10. The photovoltaic photothermal system for electric power generation according to claim 1, wherein the system is configured to adopt a butterfly arrangement to achieve higher focal ratio, the focal ratio can be up to 1 K through 10 K;
wherein the system is configured to expand room to save photovoltaic components, supposing higher requirement on light concentration photovoltaic components though, to enhance light energy conversion efficiency and thermal power generation efficiency.

11. The photovoltaic photothermal system for electric power generation according to claim 1, wherein the optical system is a channel-type reflection focusing in medium focal ratio power generation system, comprising three layers of reflection glass mirror with treated surface, three vacuum heat concentration tubes, three heat exchangers and two inter-perpendicular full-reflection flat mirrors;
wherein a light-separating structure is configured to collect sun light and utilize a 45° reflection mirror at a projection angle to realize more than 80% of infrared (IR) heat transmitted to the vacuum heat concentration tubes of the reflection light concentration mirrors; the heat storage working medium clouded in the tubes absorbs the focused high temperature heat and transfers it to the heat storage tanks, the thermomechanical working medium is then heated through the heat exchangers, which in turn drives the turbines and generators to produce electric power;
wherein the visible light energy is focused on a cylindrical reflector on a heat collector, which reflects it into a bandlike parallel high-intensity beam, the beam projects onto the multi junction dense grid concentrating photovoltaic panel located on the surface of the heat exchangers, converting the high intensity visible light energy to electric power, the visible light is separated into two inter-perpendicular beams by the flat reflection mirrors, the two beams as 90% of illumination light energy are focused on the vacuum heat concentration tubes by the full reflection mirror, the cold light mirror on the heat collection tube then transforms the focus beams into high-intensity parallel beams, which are directed onto multiple junction dense-grid concentrating photovoltaic cell panels on the heat exchangers to generate electricity directly;
wherein 50% of sunlight is distributed at upper and lower ends of the optical system, with 25% allocated to each end, which allows for electricity generation during cloudy, overcast or rainy days.

12. The photovoltaic photothermal system for electric power generation according to claim 1, wherein the optical system is configured to use a single one all-reflection mirror, at whose light axle center a vacuum heat collection tube is installed, the high energy level infrared (IR) heat energy within the focused sunlight beams is directed through the cold light lens into vacuum heat concentration tube; the heat energy is absorbed and transferred to a heat-transfer medium stored in the tube, the heated heat-transfer medium is then transported to a heat storage tank, where it heats the heat engine medium via a heat exchanger; it drives multidimensional magnetic levitation state poly-step turbine which spurs multidimensional magnetic levitation state multi-stage generator to produce electricity.
wherein a visible light focused on focal spot is reflected to parallel beams parallel to center line by a mirror plane on the vacuum heat collection tube, these beams project to the heat exchanger located on the center axis on the opposite plate, multiple junction dense grid light concentration photovoltaic cell panels are equipped on the plate opposite to the heat exchanger, which allowing for direct generation of electrical power using the high intensity parallel beams;
wherein the heat storage medium within the heat exchanger absorbs the excess heat in focused parallel strong beams and transports it to the heat storage tank, the heat is utilized to supply lower energy level heat through a heat engine medium, the heat engine medium drives multidimensional magnetic levitation state poly-stage turbine and spurs multidimensional magnetic levitation state multiple step generator to generate electric power.

13. The photovoltaic photothermal system for electric power generation according to claim 1, wherein the optical system is configured to use a single all-reflection mirror, one heat concentration tube with two inter-perpendicular cold light mirror plates is configured on the focal spot of this focus reflection lens, the tube can convert the already focused high-intensity beams into two nearly parallel reflection beams with an inter−180° angle, two box type heat exchangers are set up on the opposite plates of these two reflection beams, these heat exchangers filled with a heat storage medium is heated and then conveyed into a storage tank to heat a thermal engine working medium, causing it to gasify and drive multiple stage multidimensional magnetic levitation state turbines, this spurs multiple-stage multidimensional magnetic levitation state generators to generate electric power.

14. The photovoltaic photothermal system for electric power generation according to claim 1, wherein the system is configured to comprise two light concentration reflection lens and two vacuum heat concentration tubes on corresponding focal spots;
wherein the optical system is configured to utilize a heat reflection lens to focus and reflect invisible infrared (IR) heat energy onto the first vacuum heat concentration tube located on the focal spot, the diathermy cold light lens are placed on the plate opposite to this heat collection tube, allowing for the absorption of about 90% of the focused infrared (IR) heat energy by a heat conduction working medium in the heat concentration tube, then the heat conduction working medium is transported into a storage tank and heated to become a thermal engine working medium by heat exchangers, this thermal engine working medium drives turbines, spurring multiple-stage multidimensional magnetic levitation state generators for electric power generation;
wherein about 20% visible light energy is transformed to high intensity parallel beams to cast onto the heat exchanger located at the coaxial center, multiple junction dense grid light concentration photovoltaic cell panels are installed on the plate opposite to the heat exchanger, enabling them to directly generate electric power from a high-intensity beam's light;
wherein about 80% visible light traverses the thermal reflection lens and projects onto the second all-reflection mirror which focuses and reflects to the second vacuum heat concentration tube positioned at the center focal spot, the cold light lens on this vacuum heat concentration tube may convert 80% of visible light to high intensity parallel beams, which are then reflected onto a multiple junction dense grid light concentration photovoltaic cell panel located on the heat exchanger surface on the plate opposite to its center axis, the cell panel accepts the high-intensity parallel beams and generates electric power directly;
wherein the focused infrared (IR) light energy passes through a film layer on the cold light lens on the second vacuum heat concentration tube, where it is absorbed by the internal heat conduction working medium, which is input to a storage tank and heated to become a mechanical working medium via heat exchangers, the heated mechanical working medium drives poly-stage multidimensional magnetic levitation state turbines, resulting in the generation of power by multiple-stage multidimensional magnetic levitation state generators.
